(19) United States
(12) Patent Application Publication
(10) Pub. No.: US 2024/0205771 A1
(43) Pub. Date: Jun. 20, 2024

(54) METHODS AND APPARATUS OF LTM SUPERVISE PROCEDURE

(71) Applicant: MediaTek Singapore Pte. Ltd., Singapore (SG)

(72) Inventors: Xiaonan Zhang, Beijing (CN); Yuanyuan Zhang, Beijing (CN); Li-Chuan Tseng, HsinChu City (TW)

(21) Appl. No.: 18/531,681

(22) Filed: Dec. 6, 2023

Related U.S. Application Data
(63) Continuation of application No. PCT/CN2022/139338, filed on Dec. 15, 2022.

(30) Foreign Application Priority Data
Dec. 15, 2022 (WO) PCT/CN2022/139338
Nov. 28, 2023 (CN) 20211598842.7

(51) Int. Cl. H04W 36/08; H04W 36/00; H04W 36/24

(52) U.S. Cl. CPC H04W 36/08; H04W 36/0079; H04W 36/249

(57) ABSTRACT

Apparatus and methods are provided for supervised L1/L2-triggered mobility (LTM) cell switch. In one novel aspect, supervised LTM is performed by the UEs. In one embodiment, an LTM timer is preconfigured for the supervised LTM procedure. The UE starts the LTM timer upon receiving the cell switch command and monitors the process with the LTM timer. When the LTM timer expires and the UE fails to switch to a target cell, a recovery procedure is triggered. In one embodiment, the UE sends LTM procedure success indication explicitly through a new RRC message, a MAC CE, or DCI; or implicitly indicated by a HARQ ACK for a first downlink transmission, a first PUSCH transmission, or a first UL transmission through a PUSCH/PUCCH. In one embodiment, the recovery procedure performs an RRC re-establishment, or performs a failure recovery before the RRC re-establishment.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2022/139338, titled “METHODS AND APPARATUS OF LTM SUPERVISE PROCEDURE,” with an international filing date of Dec. 15, 2022. This application claims priority under 35 U.S.C. § 119 from Chinese Application Number 202311598842.7, titled “METHODS AND APPARATUS OF LTM SUPERVISE PROCEDURE,” filed on Nov. 28, 2023. The disclosure of each of the foregoing documents is incorporated herein by reference.

### TECHNICAL FIELD

The disclosed embodiments relate generally to wireless communication, and, more particularly, to LTM supervise procedure.

### BACKGROUND

In conventional network of 3rd generation partnership project (3GPP) 5G new radio (NR), when the UE moves from the coverage area of one cell to another cell, at some point a serving cell change needs to be performed. Currently serving cell change is triggered by layer three (L3) measurements and is done by radio resource control (RRC) reconfiguration signaling with synchronization for change of primary cell (PCell) and primary and secondary cell (PSCell), as well as release/add for secondary cells (SCells) when applicable. All cases involve complete L2 (and L1) resets, leading to longer latency, larger overhead, and longer interruption time than beam switch mobility. In order to reduce the latency, overhead and interruption time during UE mobility, the mobility mechanism can be enhanced to enable a serving cell to change via beam management with L1/L2 signaling. The L1/L2 based inter-cell mobility with beam management (LTM, L1/L2-triggered Mobility) should support the different scenarios, including intra-DU/inter-DU inter-cell cell change, FR1/FR2, intra-frequency/inter-frequency, and source and target cells may be synchronized or non-synchronized. However, how to implement LTM handover procedure to balance the efficiency and the success rate remains an issue.

Improvements and enhancements are required for cell switch with LTM procedures.

### SUMMARY

Apparatus and methods are provided for supervised L1/L2-triggered mobility (LTM) cell switch. In one novel aspect, an LTM timer is used to control the LTM handover procedure. In one embodiment, the UE obtains a LTM configuration, receives a cell switch command from the wireless network, wherein the cell switch command indicates to switch from the source cell to a target cell, starts an LTM timer to control an LTM procedure to handover from the source cell to the target cell based on the LTM configuration, and triggers a recovery procedure when the LTM timer expires. In one embodiment, the LTM timer is a RRC timer for LTM, a MAC timer for LTM or a modified T304. In one embodiment, the UE sends LTM procedure success indication to the wireless network explicitly. In one embodiment, the LTM procedure success indication is sent to the network explicitly through a new RRC message, a MAC control element (CE), or a downlink control indication (DCI). In another embodiment, the LTM procedure success indication is informed to the network implicitly, and wherein the implicit indication is delivered via a HARQ ACK for a first downlink transmission, a first physical uplink shared channel (PUSCH) transmission, or a first uplink (UL) transmission through either a PUSCH or a physical uplink control channel (PUCCH). In one embodiment, the recovery procedure performs an RRC re-establishment. The UE ranks a plurality of candidate cells to select the best cell for the RRC re-establishment. In another embodiment, the recovery procedure performs a cell selection and attempts random access (RA) to one or more candidate cells before performing the RRC re-establishment. In one embodiment, a maximum number of candidate cells for RA attempting is configured by the wireless network. In another embodiment, the recovery procedure is controlled by a preconfigured counter. In yet another embodiment, the recovery procedure sends a recovery request to a candidate cell when a dedicated PUCCH is configured for the candidate cell and uplink is synchronized with the candidate cell.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network with supervised LTM handover in accordance with embodiments of the current invention.

FIG. 2 illustrates an exemplary NR wireless system with centralized upper layers of the NR radio interface stacks in accordance with embodiments of the current invention.

FIG. 3 illustrates an exemplary deployment scenario for intra-DU inter-cell beam management in accordance with embodiments of the current invention.

FIG. 4 illustrates an exemplary deployment scenario for inter-DU inter-cell beam management in accordance with embodiments of the current invention.

FIG. 5 illustrates an exemplary diagram for LTM timer controlled LTM procedure with success in accordance with embodiments of the current invention.

FIG. 6 illustrates an exemplary diagram for LTM timer controlled LTM procedure with failed handover that triggers recovery procedure in accordance with embodiments of the current invention.

FIG. 7 illustrates an exemplary top-level diagram for LTM timer controlled LTM procedure in accordance with embodiments of the current invention.

FIG. 8 illustrates an exemplary flow diagram for the UE to successfully perform timer controlled LTM procedure in accordance with embodiments of the current invention.

FIG. 9 illustrates an exemplary flow chart for the UE to perform supervised LTM procedure and send indication for cell switch success in accordance with embodiments of the current invention.

FIG. 10 illustrates exemplary diagrams for the recovery procedures with the supervised LTM procedure in accordance with embodiment of the current inventions.

FIG. 11 illustrates an exemplary flow chart for the UE performing supervised LTM procedure with LTM timer in accordance with embodiments of the current invention.

### DETAILED DESCRIPTION

Reference will now be made in detail to some embodiments of the invention, examples of which are illustrated in the accompanying drawings.

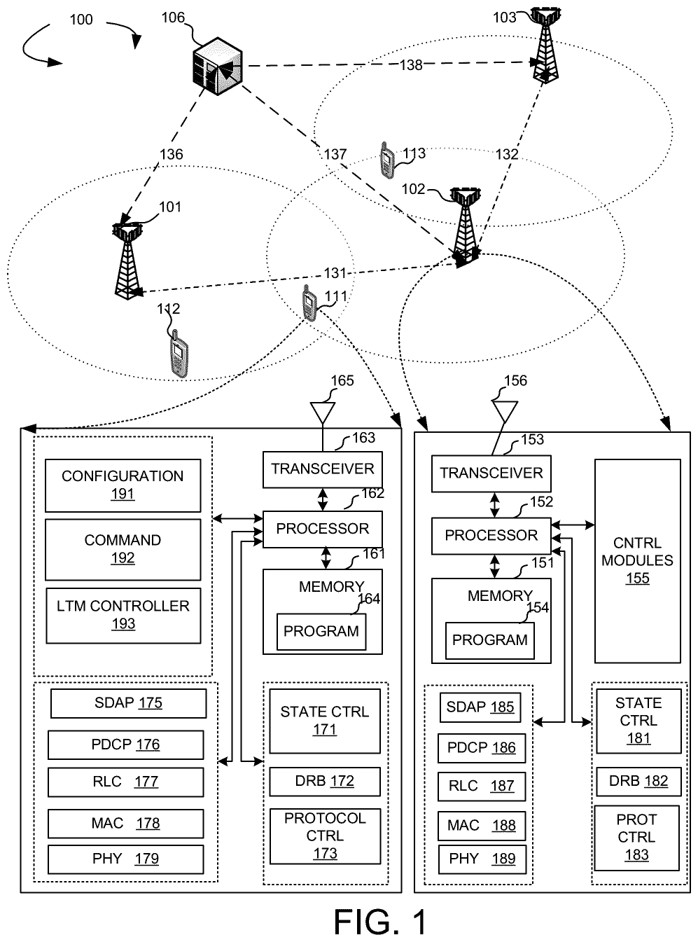

FIG. 1 is a schematic system diagram illustrating an exemplary wireless network with supervised LTM procedure in accordance with embodiments of the current invention. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB 101. UE 112 is connected with gNB 101 only. UE 111 in the overlapping service area of gNB 101 and gNB 102 and may switch back and forth between gNB 101 and gNB 102. UE 113 in the overlapping service area of gNB 102 and gNB 103 and may switch back and forth between gNB 102 and gNB 103. Base stations, such as gNB 101, 102, and 103 are connected the network through network entities, such as network entity 106 through NG connections, such as 136, 137, and 138, respectively. Xn connections 131 and 132 connect the non-co-located receiving base units. Xn connection 131 connects gNB 101 and gNB 102. Xn connection 132 connects gNB 102 and gNB 103. These Xn/NG connections can be either ideal or non-ideal.

In one novel aspect, supervised LTM is performed by the UEs, such as UE 111. In one embodiment, an LTM timer is preconfigured for the supervised LTM procedure. The UE started the LTM timer upon receiving the cell switch command and monitors the process with the LTM timer. When the LTM timer expires and the UE failed to switch to a target cell, a recovery procedure is triggered.

FIG. 1 further illustrates simplified block diagrams of a base station for supervised LTM procedure. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations. An RRC state controller 181 performs access control with corresponding UE. A DRB controller 182 performs control function to establish/add, reconfigure/modify, and release/remove a DRB based on different sets of conditions for DRB establishment, reconfiguration and release. A protocol stack controller 183 manages to add, modify or remove the protocol stack for the DRB. The protocol stack includes PHY layer 189, MAC layer 188, RLC layer 187, PDCP layer 186 and SDAP layer 185.

FIG. 1 further illustrates simplified block diagrams of a mobile device/UE for supervised LTM procedure. UE 111 has antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands transmitting and receiving. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from gNB.

UE 111 also includes a set of control modules that carry out functional tasks. These control modules can be implemented by circuits, software, firmware, or a combination of them. An RRC state controller 171 controls UE RRC state according to network's command and UE conditions. RRC supports the following states, RRC_IDLE, RRC_CONNECTED and RRC_INACTIVE. A DRB controller 172 performs control function to establish/add, reconfigure/modify, and release/remove a DRB based on different sets of conditions for DRB establishment, reconfiguration and release. A protocol stack controller 173 manages to add, modify or remove the protocol stack for the DRB. The protocol Stack includes PHY layer 179, MAC layer 178, RLC layer 177, PDCP layer 176 and SDAP layer 175. A configuration module 191 obtains a layer-1/layer-2 triggered mobility (LTM) configuration, wherein the UE is connected with a distributed unit (DU) of a source cell in a wireless network. A command module 192 receives a cell switch command from the wireless network, wherein the cell switch command indicates to switch from the source cell to a target cell. An LTM controller 193 starts an LTM timer to control an LTM procedure to handover from the source cell to the target cell based on the LTM configuration; and triggers a recovery procedure when the LTM timer expires.

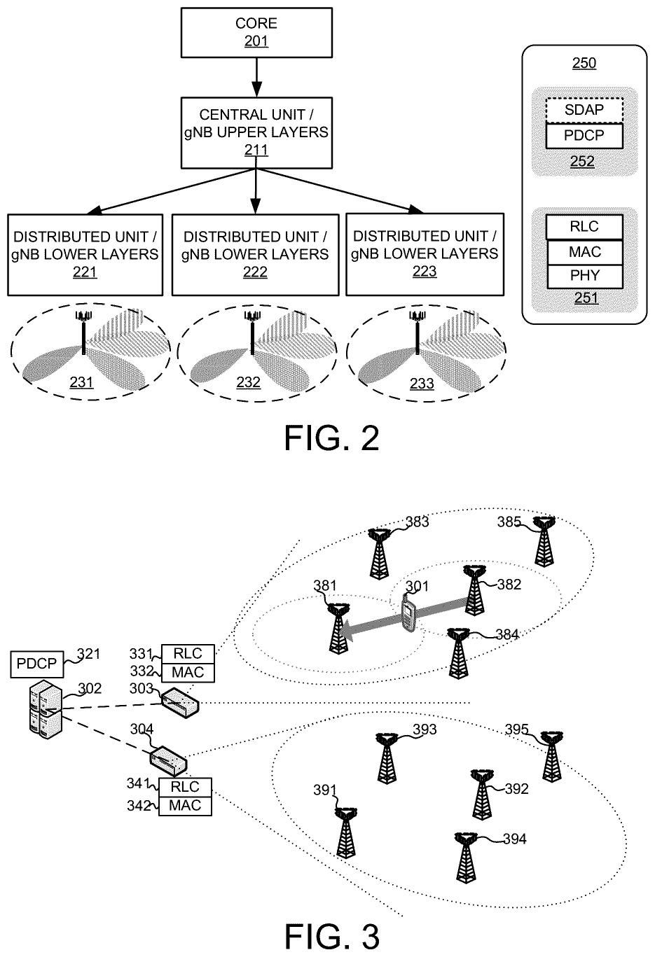

FIG. 2 illustrates an exemplary NR wireless system with centralized upper layers of the NR radio interface protocol stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each corresponds to a cell 231, 232, and 233, respectively. The DUs, such as 221, 222 and 223 include gNB lower layers 251. In one embodiment 250, gNB lower layers 251 include the PHY, MAC and the RLC layers.

FIG. 3 illustrates an exemplary deployment scenario for intra-DU inter-cell beam management in accordance with embodiments of the current invention. A CU 302 is connected to two DUs 303 and 304 through the F1 interface. CU 302 includes protocol stack PDCP 321. DU 303 includes protocol stack RLC 331 and MAC 332. DU 304 includes protocol stack RLC 341 and MAC 342. DU 303 and DU 304 are connected to multiple radio units (RUs) respectively. A cell may consist of a range covered by one or more RUs under the same DU. RUs/gNBs 381, 382, 383, 384, and 385 are connected with DU 303. RUs/gNBs 391, 392, 393, 394, and 395 are connected with DU 304. In this scenario, a UE 301 is moving from the edge of one cell served by gNB 382 to another cell served by gNB 381, which two belong to the same DU and share a common protocol stack. The supervised LTM procedure and intra-DU inter-cell beam management can be used in this scenario to replace the legacy handover process to reduce the interruption and improve the throughput of UE. In one novel aspect, supervised LTM handover is performed. In one embodiment, single protocol stack at the UE side (common RLC/MAC) is used to handle LTM.

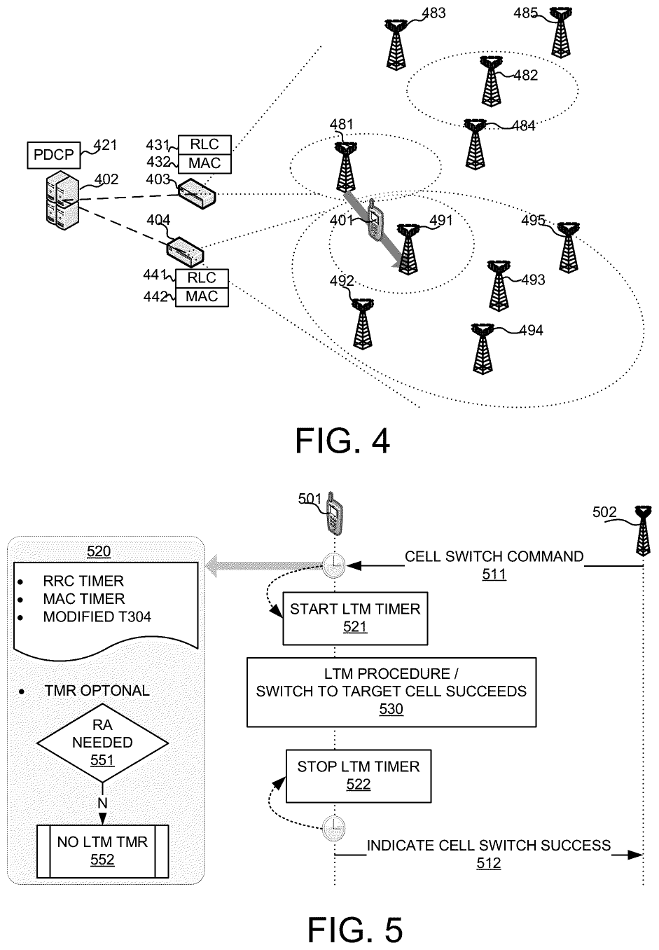

FIG. 4 illustrates an exemplary deployment scenario for inter-DU inter-cell beam management in accordance with embodiments of the current invention. A CU 402 is connected to two DUs, DU 403 and DU 404 through the F1 interface, respectively. CU 402 includes protocol stack PDCP 421. DU 403 includes protocol stack RLC 431 and MAC 432. DU 404 includes protocol stack RLC 441 and MAC 442. DU 403 and DU 404 are connected to multiple RUs respectively. A cell may consist of a range covered by one or more RUs under the same DU. RUs/gNBs 481, 482, 483, 484, and 485 are connected with DU 403. RUs/gNBs 491, 492, 493, 494, and 495 are connected with DU 404. In this scenario, a UE 401 is moving from the edge of one cell served by gNB 481 to another cell served by gNB 491, which belong to different DUs, DU 403 and DU 404, respectively, and share a common CU 402. The low layer user plane (RLC, MAC) is different in two DUs while high layer (PDCP) remains the same. Supervised LTM procedure and inter-DU inter-cell beam management can be used in this scenario to replace the legacy handover process to reduce the interruption and improve the throughput of UE. The F1 interfaces 415 and 414 are established between CU 402 and DU 403, and between CU 402 and DU 404, respectively. The F1 interfaces 414 and 415 can support high data rate with short latency, which enable the LTM handover to be performed efficiently. In one novel aspect, the inter-DU cell switch is performed with supervised LTM handover. In one embodiment, single protocol stack at the UE side (common RLC/MAC) is used to handle LTM. In one embodiment, dual protocol stack at the UE side (separate RLC/MAC) are used to handle LTM.

FIG. 5 illustrates an exemplary diagram for LTM timer controlled LTM procedure with success handover in accordance with embodiments of the current invention. UE 501 is connected with gNB 502. At step 511, UE 501 receives the cell switch command from the network. At step 521, UE 501 starts or re-starts the LTM timer. At step 530, UE 501 performs cell switch to the target cell. In one embodiment, the UE switches to the target cell successfully while the LTM timer is still running. At step 522, UE 501 stops the LTM timer. At step 512, UE 501 indicates the success of the cell switch to the network. In one embodiment, the success of the cell switch is based on the successful completion of the random access (RA) procedure if UE performs RA procedure after reception of the cell switch command. In one embodiment, the UL synchronization towards the candidate cells has been done in advance before reception of the cell switch command, and UE indicates the success of the cell switch when UE switches the beam toward the target cell.

In one embodiment 520, the LTM timer is preconfigured or dynamically indicated from the network. In one embodiment, the LTM timer is a MAC timer, and MAC indicate to RRC when the timer expires. In one embodiment, the LTM timer is a modified T304, with certain enhancement for LTM. In one embodiment, the LTM timer is a new RRC timer, e.g., T304a, similar as T304. In one embodiment, the timer is optionally configured. In one embodiment, the timer is optionally configured when RA is performed after reception of the cell switch command. The UE determines at step 551, whether RA is needed. If step 551 determines RA is not needed, at step 552, the UE determines the LTM timer is not needed. In one embodiment, the timer value is set to 0 if RA is not needed. In one embodiment, the LTM timer is not started.

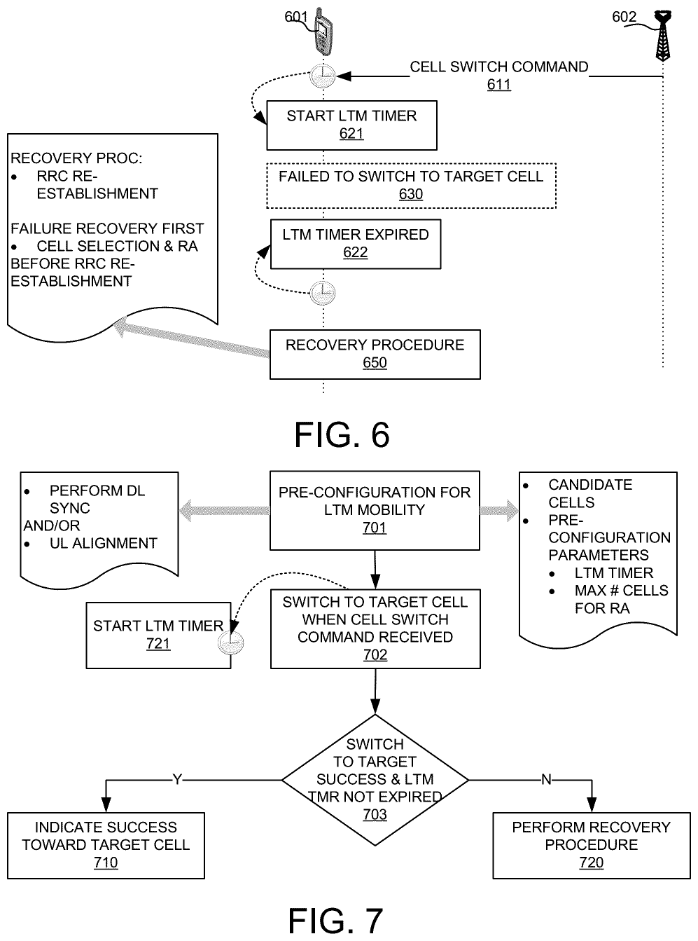

FIG. 6 illustrates an exemplary diagram for LTM timer controlled LTM procedure with failed handover that triggers recovery procedure in accordance with embodiments of the current invention. UE 601 is connected with source gNB 602. At step 611, UE 601 receives cell switch command. At step 621, UE 601 starts or restarts the LTM timer. UE 601 begins to switch to the target cell. In one embodiment 630, UE fails to switch to the target cell in time. At step 622, the LTM timer expired. At step 650, UE 601 performs recovery procedure and/or performs RRC re-establishment procedure. In one embodiment, the recovery procedure is a RRC re-establishment procedure. In another embodiment, a failure recovery procedure is performed before the RRC re-establishment. If the failure recovery procedure succeeds, no RRC re-establishment procedure is needed.

FIG. 7 illustrates an exemplary top-level diagram for LTM timer controlled LTM procedure in accordance with embodiments of the current invention. At step 701, before the cell switch, UE performs the pre-configuration procedure for LTM. In one embodiment, the pre-configuration includes one or more candidate cells for the LTM procedure. In one embodiment, the pre-configuration includes one or more parameters for the supervised LTM procedure including the LTM timer, and maximum number of candidate cell to try the RA. In one embodiment, UE performs DL synchronization and/or UL time alignment towards the candidate cells in the pre-configuration phase before reception of the cell switch command. When UE receives the cell switch command for the LTM, at step 721, UE starts the LTM timer. At step 702, the UE begins to switch to the target cell. In one embodiment, the cell switch command is transmitted via a MAC CE. At step 703, UE determines if the cell switch is successful before the LTM timer expires. In one embodiment 710, UE switches to target cell successfully when the LTM timer is still running. UE then indicates the success of the cell switch toward the target cell. In one embodiment 720, UE failed to switch to target cell in time and LTM timer expires. UE then performs the recovery procedure and/or RRC establishment procedure to reconnect to the network.

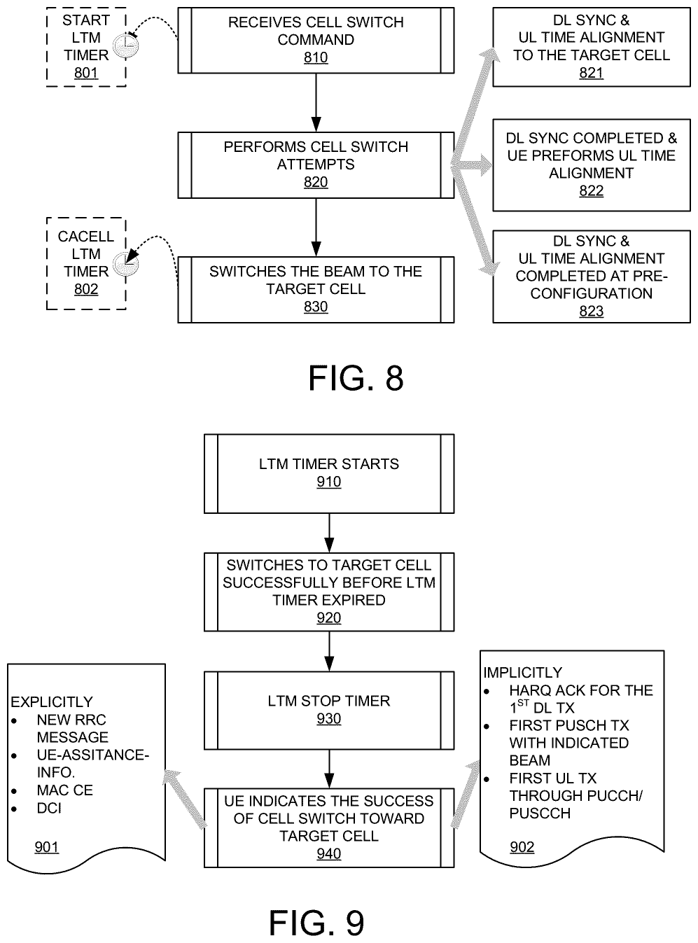

FIG. 8 illustrates an exemplary flow diagram for the UE to successfully perform timer controlled LTM procedure in accordance with embodiments of the current invention. At step 810, the UE receives the cell switch command for the LTM. At step 801, the UE starts the LTM timer. In one embodiment, the LTM timer is not needed if the RA is not needed. At step 820, the UE begins to switch to the target cell. In one embodiment 821, UE performs the DL synchronization and UL time alignment toward target cell. In one embodiment 822, the DL synchronization have been completed in pre-configuration, and UE performs the random access procedure toward target cell to obtain UL time alignment. In one embodiment 823, the DL synchronization and UL time alignment have been completed in pre-configuration. At step 830, after UE obtains the DL synchronization and UL time alignment for the target cell, UE switches the beams to the target cell. At step 802, if the LTM timer was started and running, the LTM timer is stopped/cancelled upon the success of the switching to the target cell.

FIG. 9 illustrates an exemplary flow chart for the UE to perform supervised LTM procedure and send indication for cell switch success in accordance with embodiments of the current invention. At step 910, the LTM timer starts when UE receives the cell switch command from the network. At step 920, the UE switches to the target cell successfully when the LTM timer is still running. At step 930, the UE stops the LTM timer. In one embodiment, the success of the cell switch is judged based on the successful completion of the random access procedure by UE. At step 940, the UE indicates the success of the cell switch to the target cell to the network. In one embodiment, the random access procedure is not needed, and UE indicates the success of the cell switch when UE switches the beam toward the target cell.

In one embodiment 901, UE uses an explicit indication to inform network for the success of the cell switch. In one embodiment, the explicit indication is transmitted via a new RRC message. In one embodiment, the explicit indication is transmitted via UEAssistanceInformation message. In one embodiment, the explicit indication is transmitted via a MAC control element (CE). In one embodiment, the explicit indication is transmitted via a downlink control information (DCI). In one embodiment, the explicit indication contains a cell radio network temporary identifier (C-RNTI) of the UE associated to the target cell. In another embodiment 902, UE informs the network implicitly for the success of the cell switch. In one embodiment, the indication is delivered by the HARQ ACK for the first DL transmission. In one embodiment, the indication is delivered by the first PUSCH transmission. In one embodiment, the indication is delivered by the very first UL transmission through either PUCCH or PUSCH.

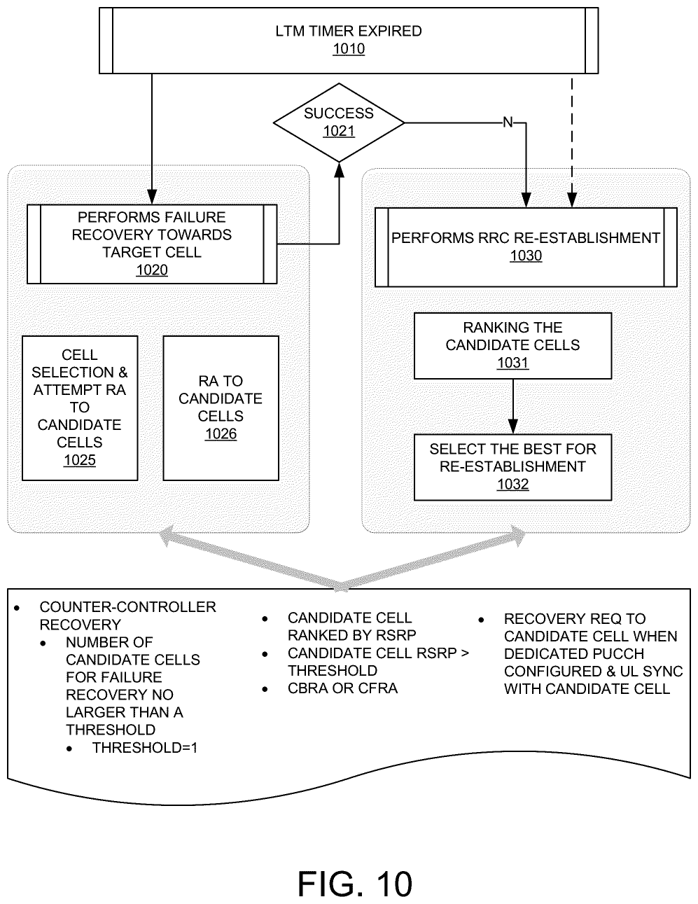

FIG. 10 illustrates exemplary diagrams for the recovery procedures for the supervised LTM procedure in accordance with embodiment of the current inventions. At step 1010, the UE failed to switch to the target cell in time and the LTM timer expires. In one embodiment, the UE moves to step 1030 and performs RRC re-establishment procedure to recover the connections. In one embodiment, at step 1031, the UE orders/ranks the quality of the candidate cells. At step 1032, the UE selects the best candidate cells for the RRC re-establishment. In one embodiment, the RSRP of the best candidate cell for RRC re-establishment should above a threshold, which is optionally configured by network.

In one embodiment 1020, UE performs additional recovery procedure/failure recovery procedure before RRC re-establishment. At step 1021, the UE determines if the failure recovery procedure is successful. The RRC re-establishment is performed only when step 1021 determines that the failure recovery procedure failed. If the connection can be recovered by the recovery procedure, UE can avoid performing the RRC re-establishment procedure. In one embodiment, the additional recovery procedure is optionally configured. In one embodiment 1025, UE performs cell selection and attempts RA procedure to the candidate cell for failure recovery if the selected cell is one of the candidate cells. If the recovery procedure fails, UE performs RRC re-establishment procedure. In another embodiment 1026, the UE performs recovery procedure via random access towards the candidate cells before the RRC re-establishment. In one embodiment, the random access procedure is a CBRA (Contention Based Random Access). In one embodiment, the random access procedure is a CFRA (Contention Free Random Access).

In one embodiment, the candidate cells used for recovery should meet certain criteria. In one embodiment, the criterion is that the RSRP of the candidate cells should be above a threshold. In one embodiment, the recovery procedure is controlled by a counter. In one embodiment, failure recovery is performed towards a number of candidate cells and the (maximum) number is configured by the network. In one embodiment, UE is only allowed to perform failure recovery procedure towards one candidate cell. In one embodiment, UE sends recovery request towards the candidate cell if dedicated PUCCH is configured for candidate cells and UL is synchronized with the candidate cell.

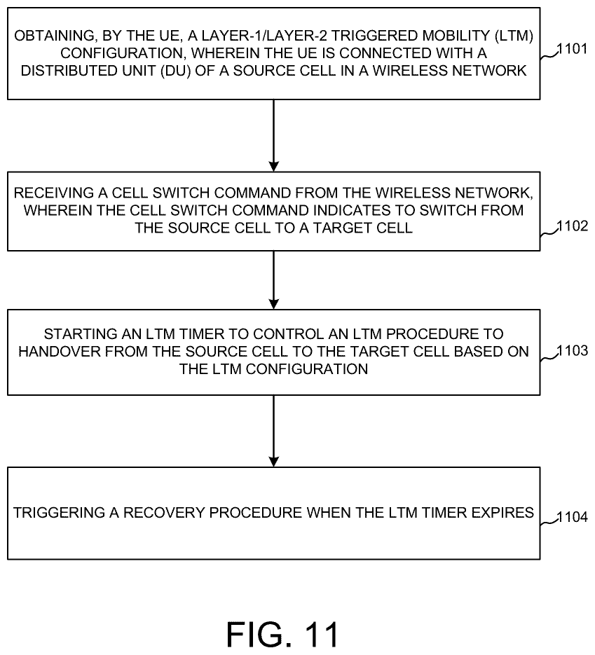

FIG. 11 illustrates an exemplary flow chart for the UE performing supervised LTM procedure with LTM timer in accordance with embodiments of the current invention. At step 1101, the UE obtains a layer-1/layer-2 triggered mobility (LTM) configuration, wherein the UE is connected with a distributed unit (DU) of a source cell in a wireless network. At step 1102, the UE receives a cell switch command from the wireless network, wherein the cell switch command indicates to switch from the source cell to a target cell. At step 1103, the UE starts an LTM timer to control an LTM procedure to handover from the source cell to the target cell based on the LTM configuration. At step 1104, the UE triggers a recovery procedure when the LTM timer expires.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE), comprising:
obtaining, by the UE, a layer-1/layer-2 triggered mobility (LTM) configuration, wherein the UE is connected with a distributed unit (DU) of a source cell in a wireless network;
receiving a cell switch command from the wireless network, wherein the cell switch command indicates to switch from the source cell to a target cell;
starting an LTM timer to control an LTM procedure to handover from the source cell to the target cell based on the LTM configuration; and
triggering a recovery procedure when the LTM timer expires.

2. The method of claim 1, wherein the LTM timer is a radio resource control (RRC) timer for LTM, a MAC timer for LTM, or a modified T304 timer.

3. The method of claim 1, further comprising: sending LTM procedure success indication to the wireless network and stopping the LTM timer when the LTM procedure succeeds.

4. The method of claim 3, wherein the LTM procedure success indication is sent to the wireless network explicitly through a new RRC message, a MAC control element (CE), or a downlink control information (DCI).

5. The method of claim 4, wherein the LTM procedure success indication contains a cell radio network temporary identifier (C-RNTI).

6. The method of claim 3, wherein the LTM procedure success indication is informed to the wireless network implicitly, and wherein the implicit indication is delivered via a HARQ ACK for a first downlink transmission, a first physical uplink shared channel (PUSCH) transmission, or a first uplink (UL) transmission through either a PUSCH or a physical uplink control channel (PUCCH).

7. The method of claim 1, wherein the recovery procedure performs an RRC re-establishment.

8. The method of claim 7, further comprising: ranking a plurality of candidate cells to select a best cell for the RRC re-establishment.

9. The method of claim 7, wherein the recovery procedure performs a cell selection and attempts random access (RA) to one or more candidate cells before performing the RRC re-establishment, and wherein the RA is a contention-based RA (CBRA) or a contention free RA (CFRA).

10. The method of claim 9, wherein a maximum number of candidate cells for RA attempting is configured by the wireless network.

11. The method of claim 1, wherein the recovery procedure is controlled by a preconfigured counter.

12. The method of claim 1, wherein the recovery procedure sends a recovery request to a candidate cell when a dedicated PUCCH is configured for the candidate cell and uplink is synchronized with the candidate cell.

13. The method of claim 1, wherein the LTM procedure succeeds when a random access (RA) to the target cell succeeds.

14. The method of claim 1, wherein RA is not needed for the LTM procedure, and wherein the LTM timer is not started.

15. A user equipment (UE), comprising:
a transceiver that transmits and receives radio frequency (RF) signal in a wireless network;
a configuration module that obtains a layer-1/layer-2 triggered mobility (LTM) configuration, wherein the UE is connected with a first distributed unit (DU) of a source cell in the wireless network;
a command module that receives a cell switch command from the wireless network, wherein the cell switch command indicates to switch from the source cell to a target cell; and
an LTM controller that starts an LTM timer to control an LTM procedure to handover from the source cell to the target cell based on the LTM configuration; and triggers a recovery procedure when the LTM timer expires.

16. The UE of claim 15, wherein the LTM timer is a radio resource control (RRC) timer for LTM, a MAC timer for LTM, or a modified T304 timer.

17. The UE of claim 15, wherein the LTM controller further sends LTM procedure success indication to the wireless network and stops the LTM timer when the LTM procedure succeeds.

18. The UE of claim 15, wherein the recovery procedure performs an RRC re-establishment.

19. The UE of claim 18, wherein the recovery procedure performs a cell selection and attempts random access (RA) to one or more candidate cells before performing the RRC re-establishment, and wherein the RA is a contention-based RA (CBRA) or a contention free RA (CFRA).

20. The UE of claim 19, wherein a maximum number of candidate cells for RA attempting is configured by the wireless network.
